(19) United States
(12) Patent Application Publication
(10) Pub. No.: US 2003/0017860 A1
(43) Pub. Date: Jan. 23, 2003

(54) Apparatus and method for generating distinctive ringing according to caller

(75) Inventor: Soo-Deok Choi, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGI-DO (KR)

(21) Appl. No.: 10/196,543

(22) Filed: Jul. 16, 2002

(30) Foreign Application Priority Data
Jul. 16, 2001 (KR) 2001-42833

(51) Int. Cl. H04M 1/00; H04B 1/38

(52) U.S. Cl. 455/567

(57) ABSTRACT

An apparatus and method for generating distinctive ringing tones according to callers. A database stores the ID of a basic ringing group including telephone numbers for which the same ringing tones are generated and the ID of each ringing group including telephone numbers for which different ringing tones are generated. A CCF detects a caller telephone number upon incoming of a call, searches for the ringing group of the caller telephone number, and assigns the ID of the ringing group to the call. An RACF receives the call with the ringing group ID from the CCF and sets the ringing group ID in a paging message for the call.

### PRIORITY

This application claims priority to an application entitled “Apparatus and Method for Generating Distinctive Ringing according to Caller” filed in the Korean Industrial Property Office on Jul. 16, 2001 and assigned Serial No. 2001-42833, the contents of which are hereby incorporated by reference.

### BACKGROUND OF THE INVENTION

1. Field of the Invention

The present invention relates generally to a mobile communication system, and in particular, to an apparatus and method for generating distinctive ringing tones for an incoming call from a telephone number in a predetermined caller group in a mobile communication system.

2. Description of the Related Art

The number of mobile users exceeds that of wired users and the mobile users receive calls from various kinds of callers through their mobile terminals. If they can know who the callers are before answering the calls, they will cope with the calls efficiently.

According to the conventional art, the mobile terminal requires the telephone number of a caller in order to process per each call. However, in case that an exchange does not transmit the telephone number of a caller for the protection of the caller's private life, the mobile terminal cannot discriminate the call and thus, an effective call processing may be not obtained.

In addition, although the mobile terminal may know the telephone number of a caller, a mobile terminal detects a telephone number from the incoming call and determines whether the telephone number has been registered for distinctive ringing in a memory. If it has, the mobile terminal generates corresponding ringing tones from the memory.

To implement the conventional distinctive ringing, the memory must have all user-registered telephone numbers for which distinctive ringing tones are generated. This implies that the memory must have a large capacity. Moreover, the search for a telephone number and detection of corresponding ringing tones in the mobile terminal increases the load of the mobile terminal.

### SUMMARY OF THE INVENTION

It is, therefore, an object of the present invention to provide an apparatus and method for generating distinctive ringing tones according to callers.

It is another object of the present invention to provide an apparatus and method for generating distinctive ringing tones according to callers without increasing the load of a mobile terminal.

It is a further object of the present invention to provide an apparatus and method for generating distinctive ringing tones according to callers so that a memory capacity requirement can be reduced.

To achieve the above and other objects, a database stores the ID of a basic ringing group including telephone numbers for which the same ringing tones are generated and the ID of each ringing group including telephone numbers for which different ringing tones are generated. A CCF (Call Control Function) detects a caller telephone number upon incoming of a call, searches for the ringing group of the caller telephone number, and assigns the ID of the ringing group to the call. An RACF (Radio Access Control Function) receives the call with the ringing group ID from the CCF and sets the ringing group ID in a paging message for the call.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of an MSC (Mobile Switching Center) according to the present invention;

FIG. 2 is a flowchart illustrating distinctive ringing in the MSC according to an embodiment of the present invention;

FIG. 3 is a flowchart illustrating distinctive ringing in the MSC according to another embodiment of the present invention;

FIG. 4 is a diagram illustrating a signal flow for the distinctive ringing in the MSC according to the embodiments of the present invention;

FIG. 5 is a flowchart illustrating distinctive ringing in a mobile terminal according to the first embodiment of the present invention; and

FIG. 6 is a flowchart illustrating distinctive ringing in the mobile terminal according to the second embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Terms used herein, “ringing group service” refers to a service of providing distinctive ringing for a predetermined caller group, and “ringing group” indicates a group of telephone numbers for which the same ringing tones are generated in the ringing group service.

While the present invention is described in the context of UMTS (Universal Mobile Telecommunication Service), it is applicable to other mobile communication systems. Distinctive ringing in an MSC and a mobile terminal will be separately described.

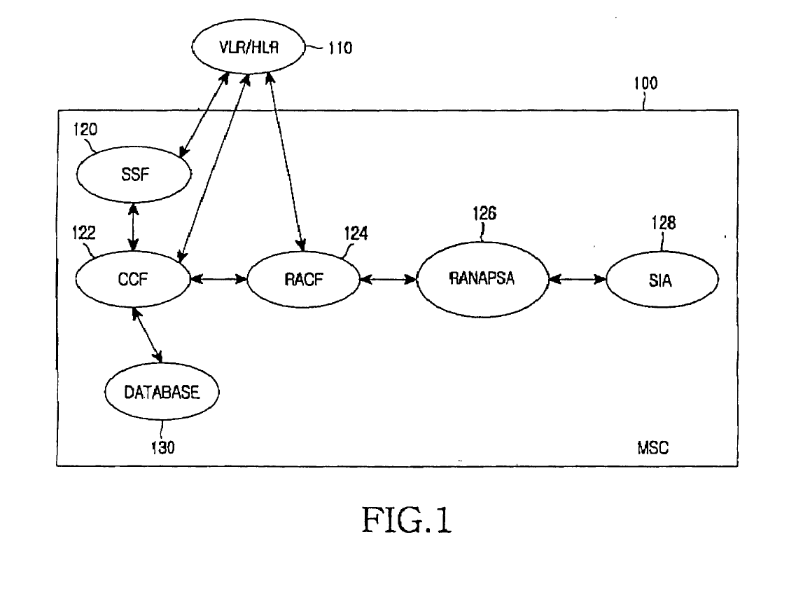

Referring to FIG. 1, an MSC 100 includes a VLR/HLR (Visitor Location Register/Home Location Register, hereinafter, referred to as a location register) 110, an SIA (Signaling Interface Agent) 128, a RANAPSA (Radio Access Application Part Signaling Agent) 126, an RACF (Radio Access Control Function) 124, a CCF (Call Control Function) 122, an SSF (Service Switching Function) 120, and a database 130.

The location register 110 is, for example, a memory for storing subscriber information such as a subscriber list. The location register 110 may be inside or outside the MSC 100. The database 130 stores data needed to implement distinctive ringing according to the present invention. The data includes the subscriber list, and is received from the location register 110 at a subscriber registration or in any other way. The CCF 122 takes charge of call processing. According to the present invention, the CCF 122 additionally detects a telephone number from an incoming call and determines whether the ringing group of the telephone number is registered in the database 130. The SSF 120 connects the location register 110 to the CCF 122 and enables the provisioning of additional services. The RACF 124 manages the resources of the RAN and assigns a ringing group ID to a call forwarded by the CCF 122. The RANAPSA 126 performs protocol conversion between the MSC 100 and a RAN (Radio Access Network). The SIA 128 interfaces the application blocks illustrated in FIG. 1 with external transport layers. The RANAPSA 126 forwards a call received from the RACF 124 to the SIA 128 and the SIA 128 transfers the call to a transport layer.

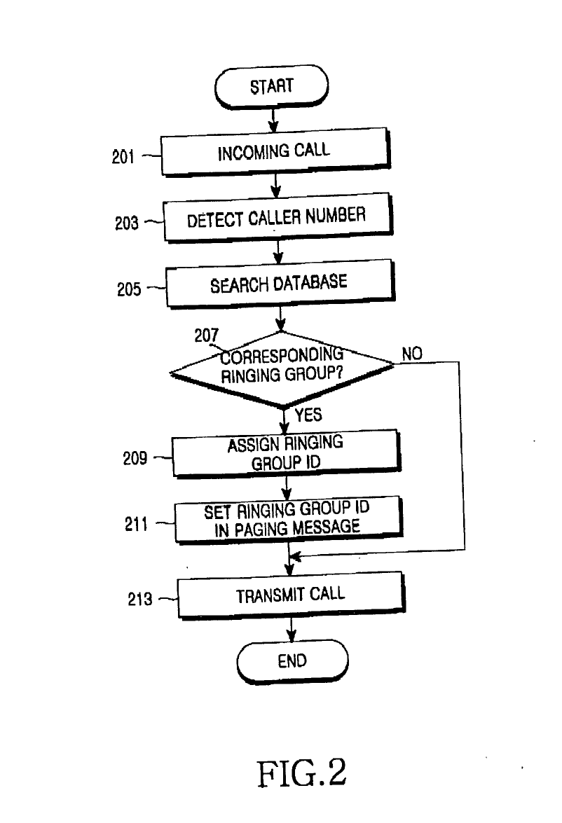

FIG. 2 is a flowchart illustrating an embodiment of the operation of the MSC for distinctive ringing according to the present invention. In the embodiment of the present invention, no ringing group ID is assigned telephone numbers that are excluded from a ringing group. The CCF 122 performs steps 201 to 209, the RACF 124 performs step 211, and a transport layer performs step 213. Data required to implement the distinctive ringing, that is, information about a subscriber list, a ringing group, and a ringing group ID is stored in the database 130. The data is received from the location register 110 or a user.

Referring to FIG. 2, the CCF 122 receives an incoming call in step 201 and detects a caller telephone number from the incoming call in step 203. The CCF 122 searches the database 130 in step 205 and determines whether the ringing group of the telephone number is stored in the database 130 in step 207. In the presence of the ringing group in the database 130, the CCF 122 goes to step 209 and in the absence of the ringing group in the database 130, it jumps to step 213. In step 209, the CCF 122 assigns the ID of the ringing group to the call. The ringing group ID is also stored in the database 130. The call with the ringing group ID is forwarded to the RACF 124 through the SSF 120. The RACF 124 sets the ringing group ID in a paging message for the call in step 211. The paging message has a structure illustrated in Table 1.

Table 1 lists the fields of the paging message according to the present invention.

TABLE 1

| | | IE Type and | | Assigned |
|---|---|---|---|---|
| IE/Group Name | Presence | Reference | Criticality | Criticality |
| Message Type | M | 9.2.1.1 | YES | Ignore |
| CN Domain | M | 9.2.1.5 | YES | Ignore |
| Indicator | | | | |
| Permanent | M | 9.2.3.1 | YES | Ignore |
| NAS UE | | | | |
| Identity | | | | |
| Temporary UE | O | 9.2.3.2 | YES | Ignore |
| Identity | | | | |
| Paging Area ID | O | 9.2.1.21 | YES | Ignore |
| Paging Cause | O | 9.2.3.3 | YES | Ignore |
| Non Searching | O | 9.2.1.22 | YES | Ignore |
| Indication | | | | |
| DRX Cycle | O | 9.2.1.37 | YES | Ignore |
| Length | | | | |
| Coefficient | | | | |

The fields in Table 1 are used for paging during call setup. Message Type is an essential information element indicating the type of a transmitted message. CN Domain Indicator indicates the circuit or packet domain of the message. Permanent NAS UE Identity identifies a UE common to a core network and a node B. Temporary UE Identity identifies a mobile subscriber instead of Permanent NAS UE Identity. Paging Area ID indicates the destination of the paging message. Paging Cause notifies a UE of a paging cause.

Among the fields of Table 1, Paging Cause is used in the present invention. Table 2 below lists the components of Paging Cause.

TABLE 2

| IE/Group Name | Presence | IE Type and Reference |
|---|---|---|
| Paging Cause | M | ENUMERATED |
| | | (Terminating Conversational Call) |
| | | Terminating Streaming Call |
| | | Terminating Interactive Call |
| | | Terminating Background Call |
| | | SMS |
| | | Ringing Group Message |

As seen from Table 2, the existing paging causes are ENUMERATED (Terminating Conversational Call), Terminating Streaming Call, Terminating Interactive Call, and Terminating Background Call SMS. In the present invention, Ringing Group Message is added to the paging causes to support the ringing group service.

The call with the above paging message is forwarded to the transport layer. In step 213, the transport layer transmits the call to a node B.

Meanwhile in the absence of the ring group in the database 130, the call is directly transmitted to the node B by the transport layer in step 213.

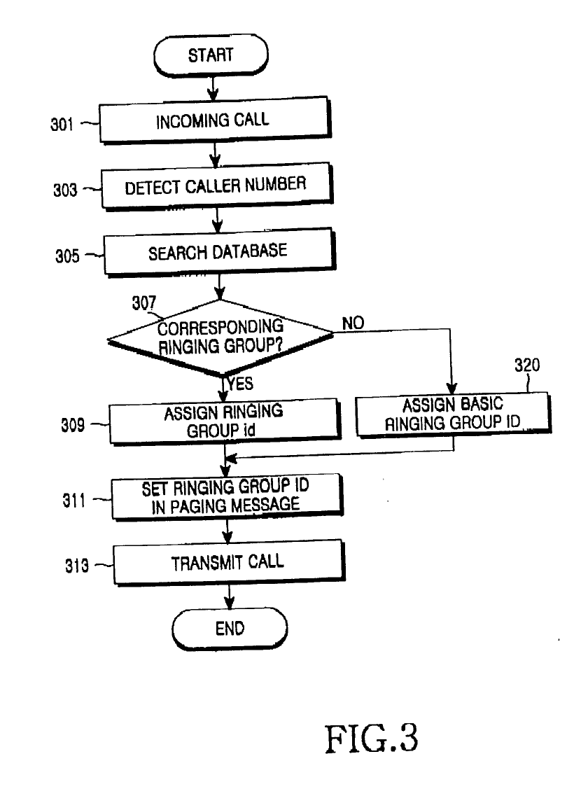

FIG. 3 is a flowchart illustrating another embodiment of the operation of the MSC for distinctive ringing according to the present invention. In this embodiment, a ringing group ID is assigned to a telephone number for which no ringing group has been set, and stored in the database 130. Such a ringing group ID is called a basic ringing group ID and ringing tones that the mobile terminal generates according to the basic ringing group ID are referred to as basic ringing tones. Therefore, a paging message for a call from a telephone number that does not belong to any ringing group has a ringing group message field for Paging Cause.

Referring to FIG. 3, the CCF 122 performs steps 301 to 309 and step 320, the RACF 124 performs step 311, and the transport layer performs step 313. Steps 301 to 307 are identical to steps 201 to 207 and thus their description is omitted. In the presence of a corresponding ringing group in the database 130, step 309 is performed. On the other hand, in the absence of the ringing group, step 320 is performed. The CCF 122 assigns a ringing group ID to an incoming call in step 309 and assigns the basic ringing group ID to the incoming call in step 320.

The incoming call with the ringing group ID is forwarded to the RACF 124. The RACF 124 sets the ringing group ID in the paging message for the call in step 311, as described before. The transport layer transmits the call of which the paging message has the ringing group ID set therein to the node B.

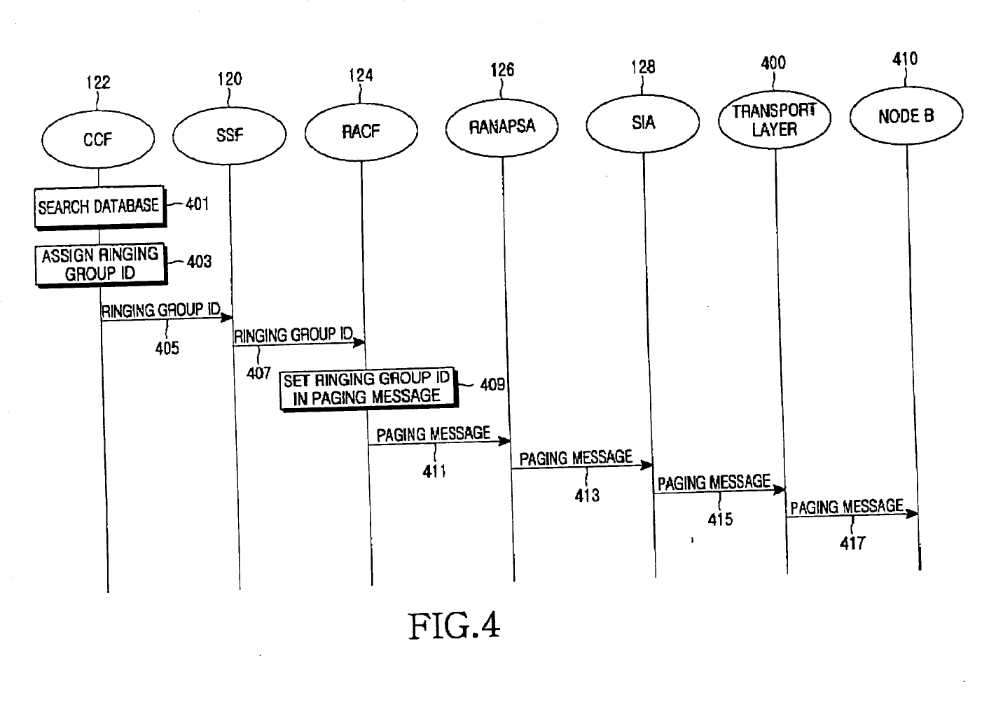

FIG. 4 is a diagram illustrating a signal flow for distinctive ringing in the MSC according to the embodiments of the present invention. An originated call is terminated at a terminated MSC via an originating node B and an originating MSC.

It is to be noted here that steps 403 to 409 are omitted in the operation of the MSC illustrated in FIG. 2 when a corresponding ringing group is absent in the database 130.

Referring to FIG. 4, upon incoming of a call, the CCF 122 searches for a corresponding ringing group in the database 130 in step 401. In the presence of the corresponding ringing group, the CCF 122 assigns the ID of the ringing group to the call in step 403. In step 405, the CCF 122 transmits a message including the ringing group ID to the SSF 120. The SSF 120 forwards the message to the RACF 124 in step 407. The RACF 124 sets the ringing group ID in the ringing group message field as a paging cause value illustrated in Table 2 in step 409.

In step 411, the RACF 124 transmits a paging message including the ringing group call to the RANAPSA 126. The RANAPSA 126 forwards the paging message to the SIA 128 in step 413 and the SIA 128 forwards the paging message to the transport layer 400 in step 415. The transport layer 400 transmits the paging message to a node B 410 in step 417.

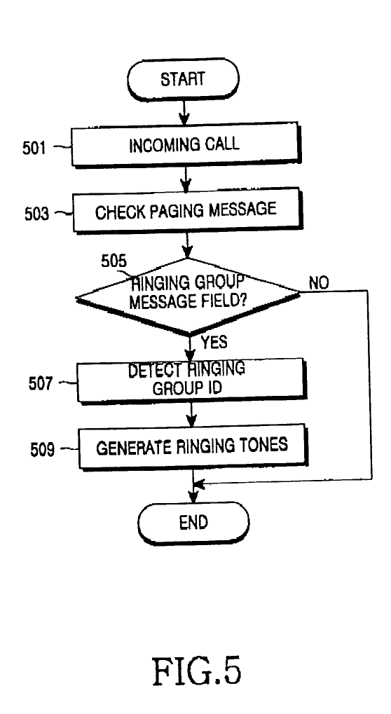

FIG. 5 is a flowchart illustrating the operation of the mobile terminal for distinctive ringing according to the first embodiment of the present invention.

Referring to FIG. 5, the mobile terminal receives a call from the node B in step 501. The call includes a paging message. The mobile terminal checks paging cause values in the paging message in step 503 and determines whether a ringing group message field exists as a paging cause value in step 505. If the ringing group message field exists, the mobile terminal detects a ringing group ID set in the ringing group message field in step 507 and generates ringing tones corresponding to the ringing group ID in step 509. On the other band, if the ringing group message field is absent, the mobile terminal generates basic ringing tones in step 509.

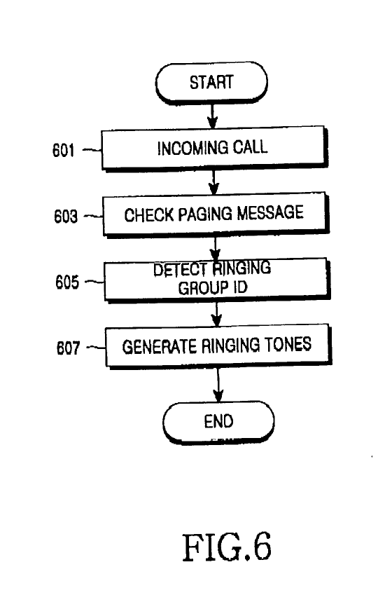

FIG. 6 is a flowchart illustrating the operation of the mobile terminal for distinctive ringing according to the second embodiment of the present invention.

Referring to FIG. 6, the mobile terminal receives a call from the node B in step 601. The call includes a paging message. The mobile terminal checks paging cause values in the paging message in step 603. In step 605, the mobile terminal reads a ringing group message field as a paging cause value and detects a ringing group ID set in the ringing group message field. In step 607, the mobile terminal generates ringing tones corresponding to the ringing group ID.

In accordance with the present invention as described above, a called may recognize the caller of an incoming call without increasing memory use in a mobile terminal. A distinctive ringing operation is performed mostly in an MSC, resulting in the decrease of mobile terminal load.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication system for informing an identity for ringing of a UE (User Equipment), comprising:
a database for storing the information of one or more caller(s) and its associated identity for ringing;
a CCF (Call Control Function) for searching for the identity for ringing corresponding to a caller in the database; and
a RACF(Radio Access Control Function) for transmitting a message including the searched identity

2. The identity for ringing of claim 1, wherein the identity for ringing is a ringing group ID.

3. The message of claim 1, wherein the message has an identity for ringing as a paging cause value to perform a ringing group service.

4. The CCF of claim 1, wherein the identity for ringing can be a default value when the CCF cannot search the identity for ringing.

5. A method for informing an identity for ringing of a UE (User Equipment), comprising the steps of:
storing the information of one or more caller(s) and its associated identity for ringing;
searching the identity for ringing corresponding to the caller in the database; and
transmitting a message including the searched identity

6. The method of claim 5, wherein the searching step further includes setting a default value when the identity for ringing cannot be searched.

7. A method of performing a ringing service in a mobile terminal, comprising the steps of:
checking a identity of ringing information in a message; and
generating ringing tones corresponding to the identity.
